(19) United States
(12) Patent Application Publication
(10) Pub. No.: US 2023/0271382 A1
(43) Pub. Date: Aug. 31, 2023

(54) EXTRUSION SYSTEM FOR FUSED FILAMENT FABRICATION

(71) Applicant: Strata Advanced Manufacturing, Macomb, MI (US)

(72) Inventor: Michael Taylor, Utica, MI (US)

(73) Assignee: Strata Advanced Manufacturing, Macomb, MI (US)

(21) Appl. No.: 18/142,747

(22) Filed: May 3, 2023

Related U.S. Application Data
(63) Continuation of application No. PCT/US2022/029786, filed on May 18, 2022.
(60) Provisional application No. 63/190,510, filed on May 19, 2021.

(51) Int. Cl. B29C 64/209; B33Y 30/00; B29C 64/295

(52) U.S. Cl. CPC B29C 64/209; B33Y 30/00; B29C 64/295; B29C 64/118

(57) ABSTRACT

A hot end assembly for an extrusion system configured for fused filament fabrication using a plurality of individual filaments includes a cold block, a hot block and a nozzle. The cold block can have a cold block body that defines a first, second and third cold block filament passages. The hot block can have a hot block body that defines a first, second and third hot block filament passages that merge into a hot block common passage at a flow merge zone. The nozzle has a nozzle tip that defines a main nozzle flow passage that terminates at a nozzle outlet. The hot block can be configured to couple to the cold block whereby the hot block filament passages align with corresponding cold block filament passages for receiving the respective plurality of individual filaments.

### CROSS-REFERENCE TO RELATED APPLICATIONS

This application is a continuation of International Application No. PCT/US2022/029786 filed May 18, 2022, which claims the benefit of U.S. Provisional Patent Application No. 63/190,510 filed on May 19, 2021, the contents of which is incorporated herein by reference.

### FIELD

The present disclosure relates generally additive manufacturing systems for printing three-dimensional components and more particularly relates to a hot end assembly in an extrusion system for fused filament fabrication.

### BACKGROUND

Additive manufacturing can be used to construct three-dimensional objects one layer at a time. Each successive layer bonds with the preceding layer of melted or martially melted material. The components are generally digitally defined by computer aided design software that allows a designer to create unique files that slice the components into ultra-thin layers. A nozzle or print head is configure to deposit new material upon a preceding layer according to predetermine specifications assigned by the layers. As material is deposited layer by layer, the end component can be formed to precise geometric shapes. One type of additive manufacturing includes fused filament fabrication (FFF) that uses a continuous filament of thermoplastic material. In general, filament is fed from a spool through a moving, heated printer extruder head and is deposited layer by layer onto a growing work. The movement of the extruder head is controlled by a computer to define the intended printed shape. It can be challenging to create high volume, high speed printed components using currently available extrusion systems.

### SUMMARY

A hot end assembly for an extrusion system configured for fused filament fabrication using a plurality of individual filaments includes a cold block, a hot block and a nozzle. The cold block can have a cold block body that defines a first, second and third cold block filament passages. The hot block can have a hot block body that defines a first, second and third hot block filament passages that merge into a hot block common passage at a flow merge zone. The nozzle has a nozzle tip that defines a main nozzle flow passage that terminates at a nozzle outlet. The hot block can be configured to couple to the cold block whereby the hot block filament passages align with corresponding cold block filament passages for receiving the respective plurality of individual filaments. The hot block in turn can be configured to heat the plurality of individual filaments as they are fed concurrently through the hot block and merge the filaments at the flow merge zone and deliver the flowable merged filaments into the main nozzle flow passage of the nozzle such that the nozzle expels a single extrusion, from the plurality of individual filaments, through the nozzle outlet.

According to other features, the hot end assembly further comprises a first, second and third heating element disposed in the hot block, the first, second and third heating elements configured to concurrently heat in parallel the respective individual filaments at the hot block filament passages. One of the cold block body and the hot block body includes a mounting boss extending proud therefrom, wherein the other of the cold block body and the hot block body defines a pocket therein that nestingly receives the mounting boss in an assembled position. The cold block body can define mounting bores therein for receiving fasteners that threadably connect with corresponding threaded bores defined in the hot block body in the assembled position.

According to additional features, the hot end assembly further includes a first, second and third feedstock tubes selectively coupled to the cold block body at the respective first, second and third filament passages. The first, second and third feedstock tubes are arranged parallel relative to each other for directing parallel feeding of the respective filaments into the cold block. The main nozzle flow passage is parallel to the first, second and third feedstock tubes. The first, second and third feedstock tubes are threadably coupled to the cold block body. The hot block and the nozzle can be integrally formed.

In other features, the cold block body further defines at least a fourth, fifth, sixth and seventh cold block filament passage. The hot block body further defines at least a fourth, fifth, sixth and seventh cold block filament passage. The hot block filament passages align with the corresponding cold block filament passages for receiving at least a fourth, fifth, sixth and seventh individual filament. The first, second, third and at least one of the fourth, fifth, sixth and seventh filaments are concurrently fed through the hot block and merged at the flow merge zone. The hot end assembly can further include a fourth, fifth and sixth heating element disposed in the hot block, the fourth, fifth and sixth heating elements configured to concurrently heat in parallel the respective individual filaments at the hot block filament passages.

A hot end assembly for an extrusion system configured for fused filament fabrication using a plurality of individual filaments according to additional features can include a cold block, a first hot block, a second hot block and a nozzle. The cold block can have a cold block body that defines a first, second, third, fourth, and at least one of a fifth, sixth and seventh cold block filament passages. The first hot block can have a first hot block body that defines a first, second and third hot block filament passages that merge into a first hot block common passage at a flow merge zone. The second hot block can have a second hot block body that defines a first, second, third and fourth hot block filament passages that merge into a second hot block common passage at a flow merge zone. The nozzle can have a nozzle tip that defines a main nozzle flow passage that terminates at a nozzle outlet. The first and second hot block is selectively and alternatively coupled to the cold block to achieve one of a three filament configuration with the first hot block or a four filament configuration with the second hot block. The hot block filament passages of the selected hot block align with corresponding cold block filament passages for receiving the respective plurality of individual filaments, the selected hot block in turn configured to heat the plurality of individual filaments as they are fed concurrently through the selected hot block and merge the filaments at the flow merge zone and deliver the flowable merged filaments into the main nozzle flow passage of the nozzle such that the nozzle expels a single extrusion, from the plurality of individual filaments, through the nozzle outlet.

According to additional features, the cold block body defines mounting bores therein for receiving fasteners that threadably connect with corresponding threaded bores defined in the selected hot block body in the assembled position. The hot end assembly can further include a third hot block having a third hot block body that defines a first, second, third, fourth, fifth, sixth and seventh hot block filament passages that merge into a third hot block common passage at a flow merge zone. The first, second or third hot block is selectively and alternatively coupled to the cold block to achieve one of (i) the three filament configuration with the first hot block; (ii) the four filament configuration with the second hot block; or (iii) a seven filament configuration with the third hot block. The cold block body defines a coolant inlet configured to receive coolant into the cold block and a coolant outlet configured to release coolant from the cold block.

In additional features, the hot end assembly further comprises a first, second, third, fourth, fifth, sixth and seventh feedstock tubes selectively coupled to the cold block body at the respective first, second, third, fourth, fifth, sixth and seventh filament passages. The hot end assembly can further comprise a first, second and third heating element disposed in the hot block, the first, second and third heating elements configured to concurrently heat in parallel the respective individual filaments at the hot block filament passages. One of the cold block body and the selected hot block body includes a mounting boss extending proud therefrom, wherein the other of the cold block body and the selected hot block body defines a pocket therein that nestingly receives the mounting boss in an assembled position. The hot end assembly can further include a first, second and third feedstock tubes selectively coupled to the cold block body at the respective first, second and third filament passages. The first, second and third feedstock tubes are arranged parallel relative to each other for directing parallel feeding of the respective filaments into the cold block, wherein the main nozzle flow passage is parallel to the first, second and third feedstock tubes.

### BRIEF DESCRIPTION OF THE DRAWINGS

The present disclosure will become more fully understood from the detailed description and the accompanying drawings, wherein:

FIG. 1 is a front perspective view of a hot end assembly constructed in accordance to one example of the present disclosure;

FIG. 2 is a schematic diagram of an exemplary extrusion system that includes the hot end assembly of FIG. 1;

FIG. 3 is a partial schematic illustration of the hot end assembly of FIG. 1 receiving filaments from respective spools according to one example;

FIG. 4 is a first sectional view of the hot end assembly taken along lines 4-4 of FIG. 1;

FIG. 5 is a second sectional view of the hot end assembly taken along lines 5-5 of FIG. 1;

FIG. 6A is a first perspective view of a cold block assembly of the hot end assembly of FIG. 1 and constructed in accordance to one example of the present disclosure;

FIG. 6B is a second perspective view of the cold block of FIG. 6A;

FIG. 6C is a top view of the cold block assembly of FIG. 6A;

FIG. 6D is a top perspective view of the cold block of the cold block assembly of FIG. 6A;

FIG. 7A is a top perspective view of a hot block assembly of the hot end assembly of FIG. 1;

FIG. 7B is a bottom perspective view of the hot block assembly of FIG. 7A;

FIG. 7C is a sectional view of the hot block assembly of FIG. 7A;

FIG. 8 is a schematic representation of the cold block assembly of FIG. 1 being used with various hot block assemblies to achieve various results based on application requirements;

FIG. 9A is a front perspective view of an exemplary workpiece formed with the extrusion system of FIG. 2;

FIG. 9B is a top view of an exemplary extrusion system configured to extrude the exemplary workpiece of FIG. 9A according to various examples;

FIG. 10A is an exploded representation of an exemplary filament channel arrangement; a resultant extrudate cross-section and a deposited bead cross-section with three layers shown according to various examples; and

FIG. 10B is an exploded representation of an exemplary filament channel arrangement; a resultant extrudate cross-section and a deposited bead cross-section with three layers shown according to various examples.

### DETAILED DESCRIPTION

Reference will now be made in detail to examples of the present disclosure. It will be understood that the following examples are not intended to limit the disclosure. On the contrary, the instant disclosure is intended to cover alternatives, modifications and equivalents, which may be included within the spirit and scope of the disclosure.

In the following description, numerous specific details are set forth to provide a thorough understanding of the presently disclosed technology. In other examples, the techniques introduced here can be practiced without these specific details. In other instances, well-known features, such as specific functions or routines, are not described in detail in order to avoid unnecessarily obscuring the present disclosure. References in this description to an “example”, “one example”, or similar terms with “example” mean that a particular feature, structure, material, or characteristic being described is included in at least one example of the present disclosure. The appearances of such phrases in this specification do not necessarily all refer to the same example. On the other hand, such references are not necessarily mutually exclusive. Furthermore, the particular features, structures, materials, or characteristics can be combined in any suitable manner in one or more examples.

It is to be understood that the various examples shown in the figures are merely illustrative representations. Further, the drawings showing examples of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

Several details describing structures or processes that are well-known and often associated with computer systems and subsystems, but that can unnecessarily obscure some significant aspects of the disclosed techniques, are not set forth in the following description for purposes of clarity. Moreover, although the following disclosure sets forth several examples of different aspects of the present technology, several other examples can have different configurations or different components than those described in this section. Accordingly, the disclosed techniques can have other examples with additional elements or without several of the elements described below.

The terms “coupled” and “connected,” along with their derivatives, can be used herein to describe structural relationships between components. It should be understood that these terms are not intended as synonyms for each other. Rather, in particular examples, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements cooperate or interact with each other (e.g., as in a cause-and-effect relationship, such as for signal transmission/reception or for function calls), or both.

The following examples are described in sufficient detail to enable those skilled in the art to make and use the invention. It is to be understood that other examples would be evident based on the present disclosure, and that system, process, or mechanical changes may be made without departing from the scope of an example of the present invention.

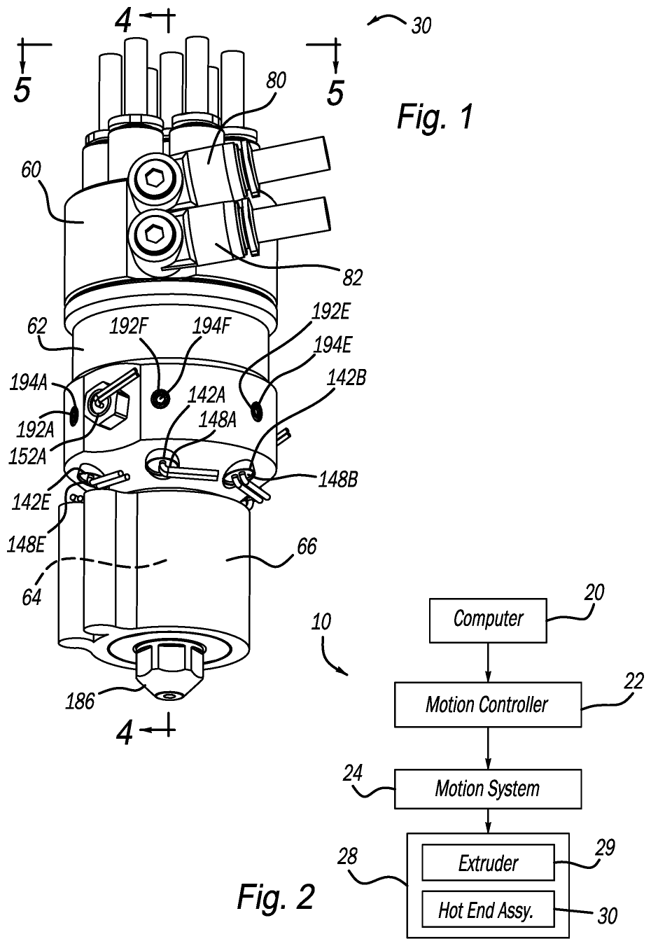

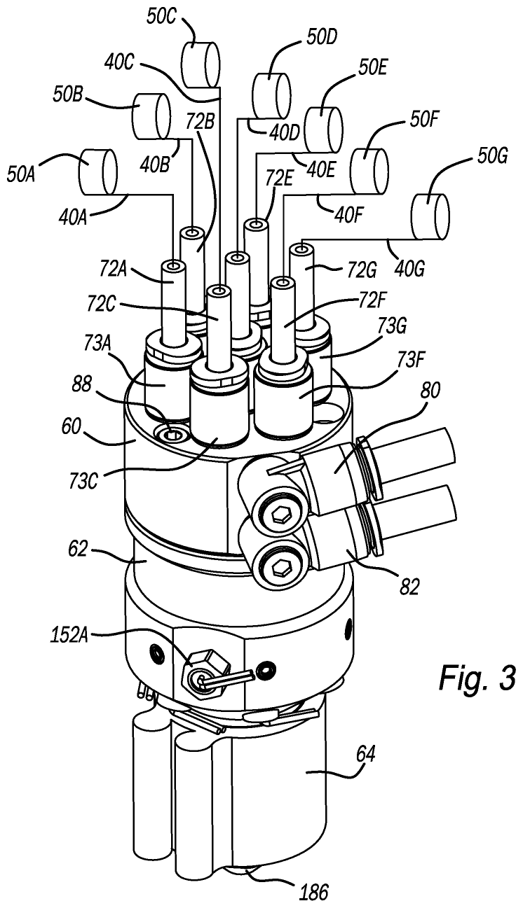

With initial reference to FIGS. 1-3, an extrusion system configured for fused filament fabrication (FFF), three-dimensional (3D) printing technology is shown and generally identified at reference 10. The extrusion system 10 is compact and achieves high rates of material deposition in a small, light package. The extrusion system 10 can include a computer 20, a motion controller 22, a motion system 24 and a deposition/extrusion system 28. In general, FFF uses material extrusion to print components such that a continuous filament is pushed through the deposition/extrusion system 28. The deposition/extrusion system 28 moves in two dimensions to deposit in sequential horizontal planes one layer at a time based on a signal delivered from the controller 22 stored and executed by the computer 20. In one example, the filament material can be in the form of a thermoplastic material wound onto a spool. As will become appreciated from the following discussion, the extrusion system 10 according to the present disclosure utilizes multiple single filaments 40A, 40B, 40C, 40D, 40E, 40F and 40G to achieve high material deposition rates with high printed part quality. In the example shown, filaments 40A, 40B, 40C, 40D, 40E, 40F and 40G are fed from respective spools 50A, 50B, 50C, 50D, 50E, 50F and 50G (FIG. 3). Many benefits are realized by employing multiple filaments 40A, 40B, 40C, 40D, 40E, 40F and 40G with a common output nozzle as will be discussed in detail herein.

The extrusion system 10 requires low system maintenance while providing light-duty and multi-axis motion system compatibility. The deposition/extrusion system 28 can include an extruder 29 and a hot end assembly 30. In general, the hot end assembly 30 directs the multiple filaments 40A, 40B, 40C, 40D, 40E, 40F and 40G along individual unique and ultimately converging paths where the individual filaments 40A, 40B, 40C, 40D, 40E, 40F and 40G are concurrently heated. The heated individual filaments 40A, 40B, 40C, 40D, 40E, 40F and 40G melt and merge into a common path where the multiple individual source filaments combine into a merged filament product that is output through a common passage in the nozzle 64. The hot end assembly 30 is designed to accommodate high volumetric flow of filament material for fast printing.

The present disclosure is directed toward using common filaments 40A, 40B, 40C, 40D, 40E, 40F and 40G with the intent on maximizing volume output with reduced time. In this regard, the hot end assembly 30 can be particularly useful in extruding large components in relatively short periods of time. The present design accomplishes high volume output with a relatively compact and lightweight hot end assembly 30. By way of example only, the filaments 40A, 40B, 40C, 40D, 40E, 40F and 40G are 1.75 mm filaments although the present disclosure can be adapted for using filaments having other diameters. It is contemplated that a light duty (and therefore less expensive) robot extruder can facilitate high volume outputs using the hot end assembly 30.

The hot end assembly 30 generally includes a cold block 60, a hot block 62 and a nozzle 64. While the exemplary hot end assembly 30 discussed herein generally comprises three components, additional or fewer components may be incorporated. In this regard, the hot end assembly 30 can be one-piece, two-piece, or multiple piece. It is contemplated that making use of additive manufacturing technology, complex (currently machined) components can be combined into an even more compact form factor. In examples, the cold block 60 and the hot block 62 can be a single or unitary piece. In the example shown, the nozzle 64 is incorporated on the hot block 62 as an integral piece, however it will be appreciated that they may be separately formed. Additive manufacturing allows complex internal features to be grown in place. A heating collar 66, receiving signals from the computer 20, can provide additional heat to the nozzle 64.

In general, the extrusion system 10 can take seven filaments 40A, 40B, 40C, 40D, 40E, 40F and 40G and feed them through the cold block 60, into the hot block 62 where they are merged and delivered into the nozzle 64 where the combined filament product is extruded out.

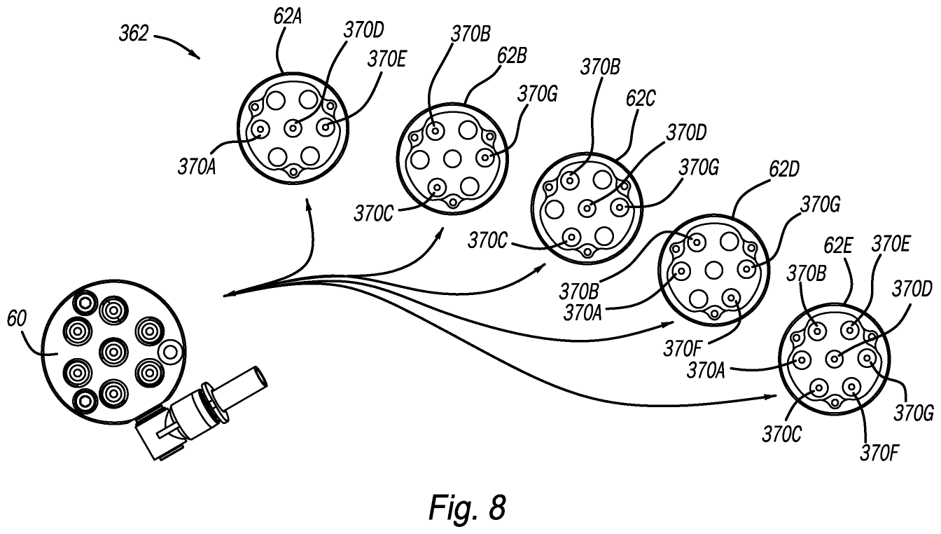

As will become appreciated from the following discussion, the cold block 60 is universal whereby different hot blocks (FIG. 8) can be attached depending upon the application requirements. In this regard, some applications may only call for an amount of filaments less than seven. As such, a corresponding hot block having a desired amount of openings can be attached to the universal cold block. The cold block 60 isolates filament conveyance from the heating system. The hot block 62 pre-heats, combines and optionally mixes molten materials. The nozzle 64 stabilizes temperature of the combined material flow.

The extrusion system 10 can run multiple motors (or one motor with multiple extrusion drives) simultaneously to extrude seven times the filament compared to conventional configurations that utilize one filament. It will be appreciated that while the present discussion is in the context of seven filaments, the same teachings may be employed for incorporating more than seven filaments. In this regard, many filament spools or sources greater than seven may be used and merged into one output within the scope of the present disclosure. Multiple single-filament remote extruders may be used. Alternatively, a custom multi-filament remote extruder or custom multi-filament direct or semi-direct extruder may be used. The filaments may be conveyed in individual tubes or bundled in a single larger tube. Remote extruders offer the lowest moving weight. Direct extruders offer higher deposition precision and are suitable for soft/elastic materials.

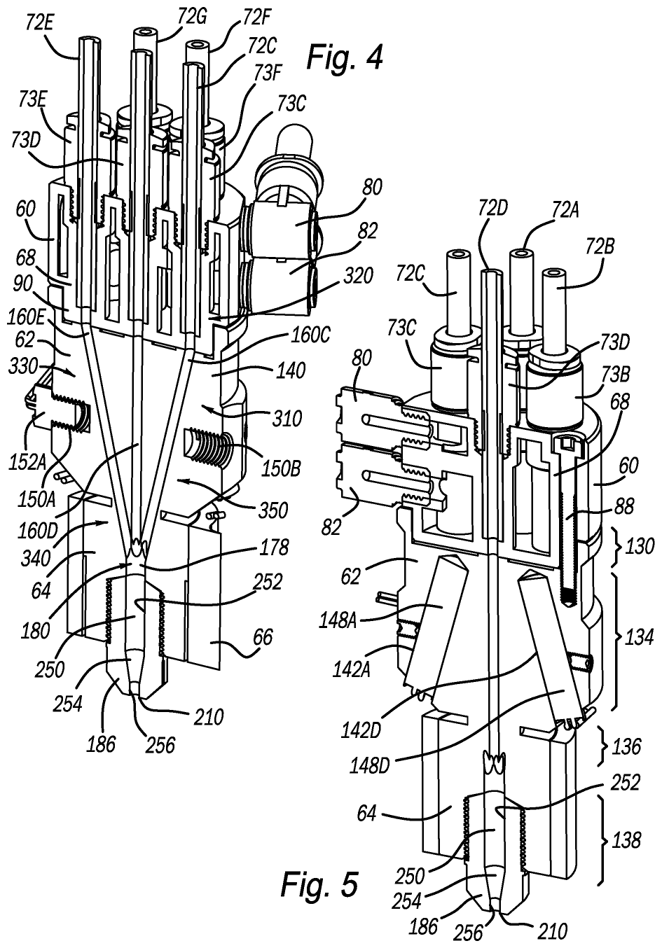

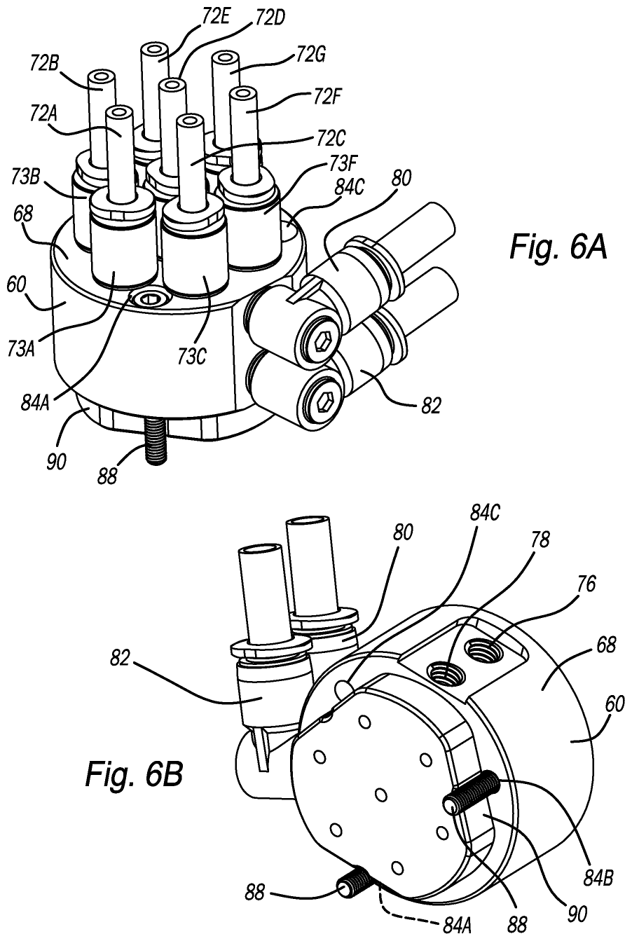

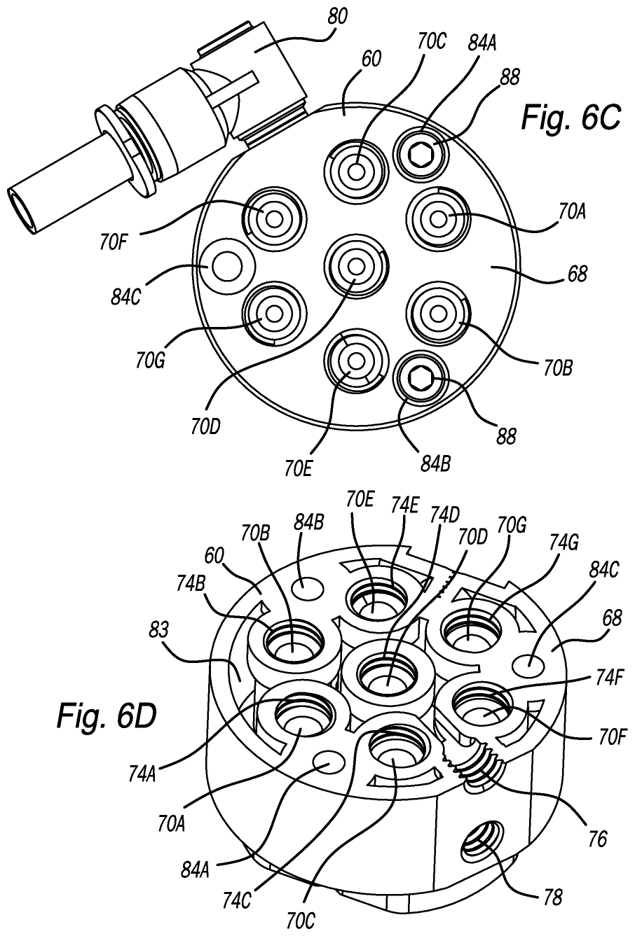

With additional reference now to FIGS. 4-7, the cold block 60 will be described in greater detail. The cold block 60 can be a fluid (air or liquid) cooled component for attaching the hot block 62 to a motion system. In general, the cold block 60 positions and aligns the filaments 40A, 40B, 40C, 40D, 40E, 40F and 40G to corresponding passages in the hot block 62. In the example shown, the cold block 60 includes a cold block body 68 that defines cold block filament passages 70A, 70B, 70C, 70D, 70E, 70F and 70G. Corresponding feedstock tubes 72A, 72B, 72C, 72D, 72E, 72F and 72G extend from boss attachments 73A, 73B, 73C, 73D, 73E, 73F and 73G that threadably mate to threaded bores 74A, 74B, 74C, 74D, 74E, 74F and 74G defined on the cold block 60 (FIG. 6D). The feedstock tubes 72A, 72B, 72C, 72D, 72E, 72F and 72G can be used as part of push-connect fittings.

The cold block body 68 further defines coolant inlet and outlets 76, 78 that receive and send coolant communicated through coolant lines 80, 82 (FIG. 1). Coolant can flow into and out of a coolant cavity 83 (FIG. 6D) defined in the cold block 60 providing a cooling function to the cold block body 68. Mounting bores 84A, 84B and 84C are defined on the cold block body 68 for receiving cap screws 88. The cold block body 68 includes a mounting boss 90 that extends proud from a bottom surface of the cold block body 68.

The cap screws 88 can threadably mate with corresponding threaded bores 92A, 92B and 92C defined in the hot block 62. While only two cap screws 88 are shown, it is appreciated that three cap screws 88 may be used for mating into each of the threaded bores 92A, 92B and 92C to retain the hot block 62 relative to the cold block 60. In one advantage, the hot block 62 (with or without the nozzle 64) can be easily swapped out with another hot block and nozzle assembly by loosening the cap screws 88.

Turning now to FIGS. 8-13, the hot block 62 will be further described. The hot block 62 preheats, combines and optionally mixes the molten materials (filaments). The hot block 62 generally comprises four distinct zones or portions, a cold block attachment portion 130, a heating zone 134, a flow merge zone 136 and a nozzle tip attachment portion 138.

The hot block 62 includes a hot block body 140 that defines heater bores 142A, 142B, 142C, 142D, 142E and 142F for receiving corresponding heating elements 148A, 148B, 148C, 148D, 148E and 148F. Temperature sensor receiving bores 150A and 150B are defined in the hot block body 140 for receiving temperature sensors, such as temperature sensor 152A (FIG. 5). The temperature sensors communicate signals to the computer 20 indicative of a temperature at the hot block 62. The hot block body 140 further defines unique hot block filament passages 160A, 160B, 160B, 160C, 160D, 160E, 160F and 160G that align with corresponding cold block filament passages 70A, 70B, 70C, 70D, 70E, 70F and 70G. In this regard, the individual filaments 40A, 40B, 40C, 40D, 40E, 40F and 40G that are fed through the respective cold block filament passages 70A, 70B, 70C, 70D, 70E, 70F and 70G are subsequently received into the hot block filament passages 160A, 160B, 160C, 160D, 160E, 160F and 160G. The hot block body 140 defines a pocket 162 that nestingly receives the mounting boss 90 of the cold block body 68.

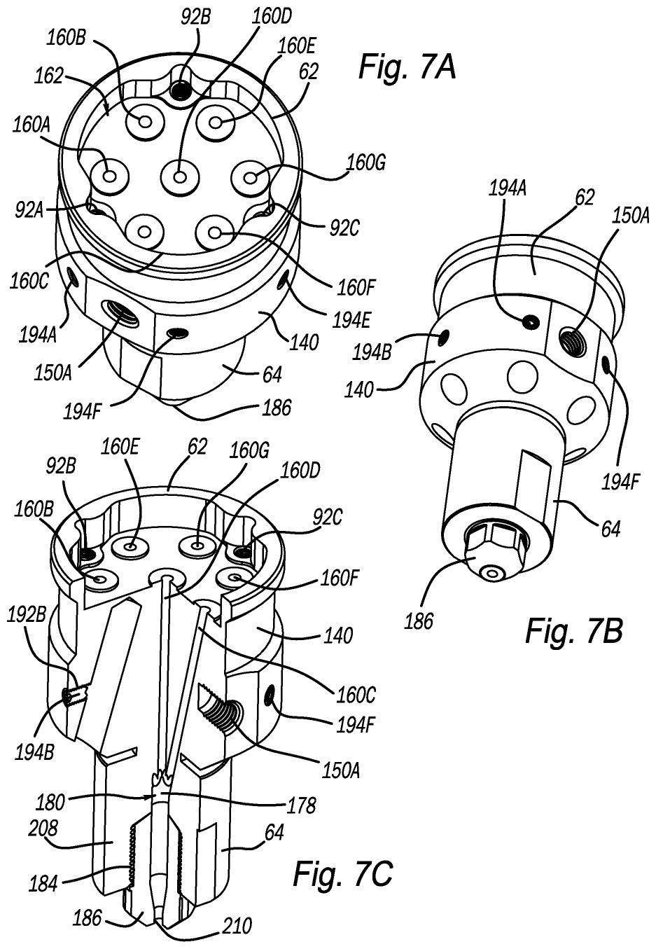

As can be appreciated, the heating elements 148A, 148B, 148C, 148D, 148E and 148F disposed in the heater bores 142A, 142B, 142C, 142D, 142E and 142F heat the hot block 62 and consequently concurrently heat the individual filaments 40A, 40B, 40C, 40D, 40E, 40F and 40G, in parallel, as they are fed through the hot block body 140. The hot block filament passages 160A, 160B, 160C, 160D, 160E, 160F and 160G merge into a hot block common passage 178 (FIG. 7C) at a flow merge zone 180 that terminates at a nozzle receiving bore 184 defined in a nozzle body portion 208. In one example, the nozzle receiving bore 184 can threadably receive a nozzle tip 186.

The hot block body 140 further defines threaded bores 192A, 192B, 192C, 192D, 192E and 192F that are configured to receive corresponding threaded fasteners 194A, 194B, 194C, 194D, 194E and 194F used to fix the respective heaters 148A, 148B, 148C, 148D, 148E and 148F within the heater bores 142A, 142B, 142C, 142D, 142E and 142F.

The hot block 62 provides an axisymmetric design that facilitates several key features and advantages. For example, the hot block 62 ensures consistent heating to all filament passages 160A, 160B, 160C, 160D, 160E, 160F and 160G. Heating of the respective filaments 40A, 40B, 40C, 40D, 40E, 40F and 40G is accomplished in parallel (compact parallel extrusion) allowing melting of the filaments 40A, 40B, 40C, 40D, 40E, 40F and 40G concurrently rather in series. Further, the heating process of the filaments 40A, 40B, 40C, 40D, 40E, 40F and 40G is efficient in that shared heaters 148A, 148B, 148C, 148D, 148E and 148F and short heat transfer paths are employed. Explained differently, because the filaments 40A, 40B, 40C, 40D, 40E, 40F and 40G are concurrently individually heated, the height of the hot block 62 can be relatively compact (short) while still effectively heating each filament 40A, 40B, 40C, 40D, 40E, 40F and 40G to desired levels. As identified above, the particular configuration can be extendible and be used for larger systems that employ more than seven filaments. Swirling, tumbling and/or other flow elements can be incorporated to ensure all feedstock is suitably mixed.

With reference to FIG. 7C, the nozzle 64 will be further described. The nozzle 64 provides the final handling and delivery point of the filament and stabilizes the flow of the filament out of the nozzle 64. The nozzle tip 186 can define a nozzle outlet 210. By way of example, the nozzle outlet 210 is 2 mm. Other nozzles having other geometries may be used. The nozzle 64 provides a smooth transition from the flow merge zone 136 of the hot block 62 into and through the nozzle outlet 210 of the nozzle tip 186 at the nozzle tip attachment portion 138.

With particular reference now to FIG. 4, the nozzle tip 186 will be further described. The nozzle tip 186 defines a main nozzle flow passage 250. In examples, the main nozzle flow passage 250 can define an axis parallel to corresponding axes of the respective feedstock tubes feedstock tubes 72A, 72B, 72C, 72D, 72E, 72F and 72G. The geometric relationship allows for optimized flow of the filaments. The main nozzle flow passage 250 transitions from a first main passage 252, an intermediate reduction passage 254 and a final output passage 256 that leads to the outlet 210. It will be appreciated that the geometry of the nozzle 64 can be optimized for multi-axis, non-planar, or direction-dependent deposition features. In one non-limiting example, the nozzle tip 186 can be formed of brass.

With continued reference to FIG. 4 additional features of the present disclosure will be described. The hot end assembly 30 provides a flow path, collectively identified at 310. The flow path 310 is generally comprised of a first flow path portion 320 through the cold block 60, a second flow path portion 330 through the hot block 62 and a third flow path portion 340 through the nozzle 64. The geometry of the respective passages that make up the flow path 310 optimizes performance of the hot end assembly 30. The flow path is designed for low pressure loss through a melt zone 350. The cross-sectional area of the molten filaments is reduced smoothly as the material proceeds along the flow path 310. In this regard, sharp transitions that can otherwise cause a pressure drop diminishing flow rate are eliminated. Further, voids and/or expansions along the flow path 310 that may otherwise trap air and reduce print quality are mitigated with the instant design. Multiple filaments, in the example shown seven, can be heated in parallel using a compact hot block. The overall height of the extrusion system 28 can be about 25% of the height of current market extrusion systems allowing for distinct advantages when using the extrusion system in tight spaces or where z-height availability is limited. Additionally, the hot block is much lighter than conventional offerings. As such, robots needing to move the hot block do not necessarily need to have heavy weight payload capacities thereby reducing costs in hardware requirements.

Turning now to FIG. 8, additional features of the instant application will be described. The cold block 60 is universally formed such that it can selectively and alternatively accept different hot blocks, collectively identified at 362 and individually identified at reference numerals 62A, 62B, 62C, 62D and 62E. The different hot blocks can be selected based upon application requirements for volumetric flow and/or arrangement. For example, the hot block 62A can include open passages 370A, 370D and 370E arranged generally in a linear pattern. There are no other passages open in the hot block 62A. When running the hot block 62A, three corresponding filaments 40A, 40D and 40E are delivered concurrently into the cold block 60 and then into the hot block 62A.

The hot block 62B can include open passages 370B, 370C and 370G generally in a triangular pattern. There are no other passages open in the hot block 62B. When running the hot block 62B, three corresponding filaments 40B, 40C and 40G are delivered concurrently into the cold block 60 and then into the hot block 62B.

The hot block 62C can include open passages 370B, 370C, 370D and 370G. There are no other passages open in the hot block 62C. When running the hot block 62C, four corresponding filaments 40B, 40C, 40D and 40G are delivered concurrently into the cold block 60 and then into the hot block 62C.

The hot block 62D can include open passages 370A, 370B, 370G and 370F generally in a rectangular pattern. There are no other passages open in the hot block 62D. When running the hot block 62D, four corresponding filaments 40A, 40B, 40G and 40F are delivered concurrently into the cold block 60 and then into the hot block 62 D.

The hot block 62E can include all open passages 370A, 370B, 370C, 370D, 370E, 370F and 370G. The hot block 62E can be configured as the hot block 62 described above. When running the hot block 62E, seven corresponding filaments 40A, 40B, 40C, 40D, 40E, 40F and 40G are delivered concurrently into the cold block 60 and then into the hot block 62E.

Different and interchangeable nozzle tips 186 having different inlet diameters and outlet diameters may be also provided for optimizing the desired flow capacity based on the amount of passages that are open. It will be appreciated that the selected nozzle tip can dictate the width of the printed bead. A smaller outlet diameter nozzle tip can be used for fine detail work whereas a larger outlet diameter nozzle tip can be used for strength.

In examples, the computer 20 will send signals to operate, such as by pulse width modulation (PWM), the heating elements 148A, 148B, 148C, 148D, 148E and 148F based on the amount of open passages 370A, 370B, 370C, 370D, 370E, 370F and 370G. In other words, less heating power is needed and requested when running one filament through one open passage as compared to running seven filaments through all passages 370A, 370B, 370C, 370D, 370E, 370F and 370G. Regardless, the computer 20 communicates signals to the heating elements 148A, 148B, 148C, 148D, 148E and 148F consistent to optimally heat the filament or filaments passing through the hot block 62. In examples, the computer 20 can have previously defined temperature setpoints associated with an amount (or type) of filaments being used in a given application. Signals can be communicated, such as by PWM, to the heaters to achieve the desired temperature setpoints. The temperature setpoints can be verified by the temperature sensors (such as sensor 152A).

In advantages of the instant hot end assembly 30, a user can easily swap out any of the hot blocks 62A, 62B, 62C, 62D and 62E by unscrewing and re-screwing the cap screws 88. In this regard, re-configuring the hot end assembly from one job to the next is relatively simple and downtime is minimized. In other advantages, the hot end assembly 30 can be modified by swapping out any of the hot blocks based on a desired volumetric flow for a given application. As can be appreciated overlap exists where the same volumetric flow can be achieved with the hot block 62B using three filaments through the three open passages as compared to using the hot block 62E using seven filaments through the seven open passages by modifying the feed rate of the filaments. In other words, a three filament setup can be fed at a faster rate compared to a seven filament setup while still having the same or near the same volumetric flow.

The extrusion system 10 can achieve much higher volumetric flows compared to prior art offerings. In examples, the extrusion system 10 can handle 100-10,000 mm³/second flow rate as compared to prior art sequential multi-filament offerings that can handle 10 mm³/second flow rates or concurrent multi-filament offerings that can handle 20 mm³/second flow rates. The concurrent multi-filament prior art offerings cannot efficiently accommodate parallel feeding of multiple filaments through the hot block. While some high speed single filament offerings can provide maximum volumetric flow of 500 mm³/second, these systems do not provide the multi-axis capability of the extrusion system 10 and are more complex. Similarly, a pellet fed system can provide 40,000 mm³/second flow rates but suffers from having relatively poor multi-axis capability.

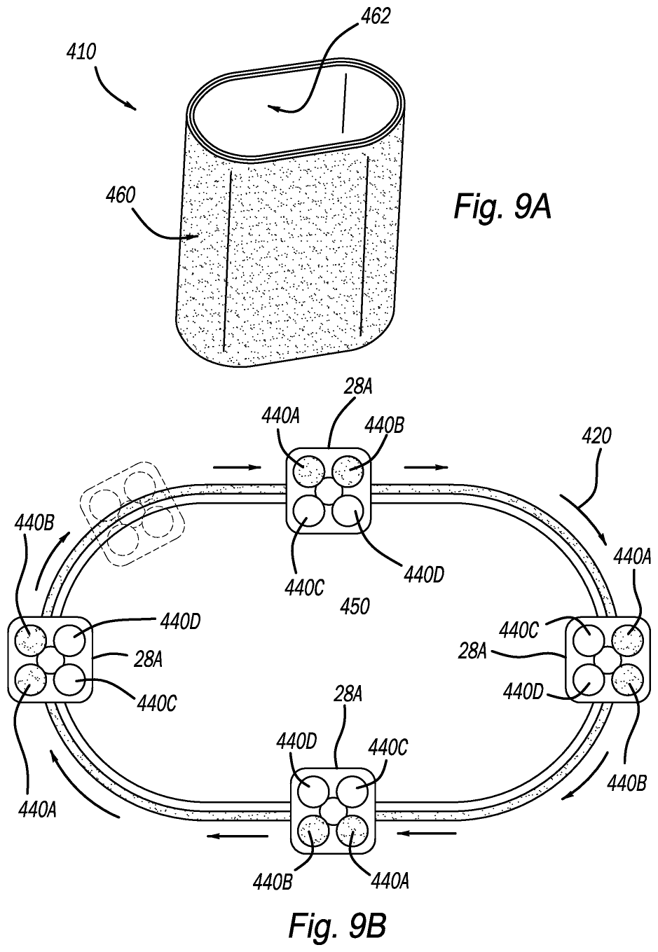

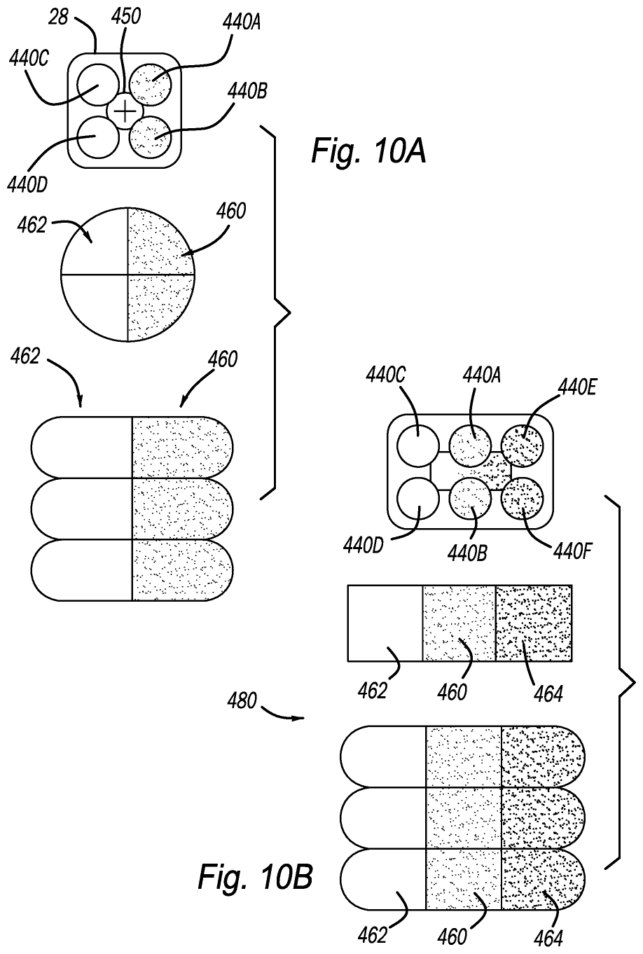

Turning now to FIGS. 9A-10B, additional features of the instant application will be described. FIG. 9 illustrates an exemplary workpiece formed using the hot end assembly is shown and generally identified at reference 410. The workpiece 410 is formed by the extrusion system 28A. The workpiece 410 The extrusion system 28A is configured as a multi-axis extrusion system 28A. In the example shown, the extrusion system 28A can generally follow a path 420 so that the orientation of the pattern of filaments can be controlled. In the example shown in FIG. 9B, two filaments 440A and 440B of a first like color and two filaments 440C and 440D of a second like color are used and output through an outlet 450 of the nozzle. A controlled deposition of a mixture can be used to complete the workpiece 410. Cross-sections of the extruded material shown in FIG. 10A where the filaments 440A and 440B generally contribute to first material 460 and the filaments 440C and 440D generally contribute to second material 462.

FIG. 10B illustrates an exemplary workpiece formed using a hot end assembly configured for six filaments. In the example shown in FIG. 10B, two filaments 440A and 440B of a first like color, two filaments 440C and 440D of a second like color, and two filaments 440E and 440F of a third like color are used and output through an outlet of the nozzle. A controlled deposition of a mixture can be used to complete a workpiece 480. Cross-sections of the extruded material shown in FIG. 10B where the filaments 440A and 440B generally contribute to first material 460 and the filaments 440C and 440D generally contribute to second material 462 and the filaments 440E and 440F generally contribute to third material 464.

The foregoing description of the many examples has been provided for purposes of illustration and description. It is not intended to be exhaustive or to limit the disclosure. Individual elements or features of a particular aspect are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A hot end assembly for an extrusion system configured for fused filament fabrication using a plurality of individual filaments, the hot end assembly comprising:
a cold block having a cold block body that defines a first, second and third cold block filament passages;
a hot block having a hot block body that defines a first, second and third hot block filament passages that merge into a hot block common passage at a flow merge zone; and
a nozzle having a nozzle tip that defines a main nozzle flow passage that terminates at a nozzle outlet;
wherein the hot block is configured to couple to the cold block whereby the hot block filament passages align with corresponding cold block filament passages for receiving the respective plurality of individual filaments, the hot block in turn configured to heat the plurality of individual filaments as they are fed concurrently through the hot block and merge the filaments at the flow merge zone and deliver the flowable merged filaments into the main nozzle flow passage of the nozzle such that the nozzle expels a single extrusion, from the plurality of individual filaments, through the nozzle outlet.

2. The hot end assembly of claim 1, further comprising a first, second and third heating element disposed in the hot block, the first, second and third heating elements configured to concurrently heat in parallel the respective individual filaments at the hot block filament passages.

3. The hot end assembly of claim 1 wherein one of the cold block body and the hot block body includes a mounting boss extending proud therefrom, wherein the other of the cold block body and the hot block body defines a pocket therein that nestingly receives the mounting boss in an assembled position.

4. The hot end assembly of claim 3 wherein the cold block body defines mounting bores therein for receiving fasteners that threadably connect with corresponding threaded bores defined in the hot block body in the assembled position.

5. The hot end assembly of claim 1 wherein the cold block body defines a coolant inlet configured to receive coolant into the cold block and a coolant outlet configured to release coolant from the cold block.

6. The hot end assembly of claim 1, further comprising a first, second and third feedstock tubes selectively coupled to the cold block body at the respective first, second and third filament passages.

7. The hot end assembly of claim 6 wherein the first, second and third feedstock tubes are arranged parallel relative to each other for directing parallel feeding of the respective filaments into the cold block.

8. The hot end assembly of claim 6 wherein the main nozzle flow passage is parallel to the first, second and third feedstock tubes.

9. The hot end assembly of claim 6 wherein the first, second and third feedstock tubes are threadably coupled to the cold block body.

10. The hot end assembly of claim 1 wherein the hot block and the nozzle are integrally formed.

11. The hot end assembly of claim 1 wherein:
the cold block body further defines at least a fourth, fifth, sixth and seventh cold block filament passage;
the hot block body further defines at least a fourth, fifth, sixth and seventh cold block filament passage;
wherein the hot block filament passages align with the corresponding cold block filament passages for receiving at least a fourth, fifth, sixth and seventh individual filament;
wherein the first, second, third and at least one of the fourth, fifth, sixth and seventh filaments are concurrently fed through the hot block and merged at the flow merge zone.

12. The hot end assembly of claim 2, further comprising:
a fourth, fifth and sixth heating element disposed in the hot block, the fourth, fifth and sixth heating elements configured to concurrently heat in parallel the respective individual filaments at the hot block filament passages.

13. A hot end assembly for an extrusion system configured for fused filament fabrication using a plurality of individual filaments, the hot end assembly comprising:
a cold block having a cold block body that defines a first, second, third, fourth, and at least one of a fifth, sixth and seventh cold block filament passages;
a first hot block having a first hot block body that defines a first, second and third hot block filament passages that merge into a first hot block common passage at a flow merge zone;
a second hot block having a second hot block body that defines a first, second, third and fourth hot block filament passages that merge into a second hot block common passage at a flow merge zone; and
a nozzle having a nozzle tip that defines a main nozzle flow passage that terminates at a nozzle outlet;
wherein the first and second hot block is selectively and alternatively coupled to the cold block to achieve one of a three filament configuration with the first hot block or a four filament configuration with the second hot block, whereby the hot block filament passages of the selected hot block align with corresponding cold block filament passages for receiving the respective plurality of individual filaments, the selected hot block in turn configured to heat the plurality of individual filaments as they are fed concurrently through the selected hot block and merge the filaments at the flow merge zone and deliver the flowable merged filaments into the main nozzle flow passage of the nozzle such that the nozzle expels a single extrusion, from the plurality of individual filaments, through the nozzle outlet.

14. The hot end assembly of claim 13 wherein the cold block body defines mounting bores therein for receiving fasteners that threadably connect with corresponding threaded bores defined in the selected hot block body in the assembled position.

15. The hot end assembly of claim 13, further comprising:
a third hot block having a third hot block body that defines a first, second, third, fourth, fifth, sixth and seventh hot block filament passages that merge into a third hot block common passage at a flow merge zone;
wherein the first, second or third hot block is selectively and alternatively coupled to the cold block to achieve one of (i) the three filament configuration with the first hot block; (ii) the four filament configuration with the second hot block; or (iii) a seven filament configuration with the third hot block.

16. The hot end assembly of claim 13 wherein the cold block body defines a coolant inlet configured to receive coolant into the cold block and a coolant outlet configured to release coolant from the cold block.

17. The hot end assembly of claim 13, further comprising a first, second, third, fourth, fifth, sixth and seventh feedstock tubes selectively coupled to the cold block body at the respective first, second, third, fourth, fifth, sixth and seventh filament passages.

18. The hot end assembly of claim 13, further comprising a first, second and third heating element disposed in the hot block, the first, second and third heating elements configured to concurrently heat in parallel the respective individual filaments at the hot block filament passages.

19. The hot end assembly of claim 13 wherein one of the cold block body and the selected hot block body includes a mounting boss extending proud therefrom, wherein the other of the cold block body and the selected hot block body defines a pocket therein that nestingly receives the mounting boss in an assembled position.

20. The hot end assembly of claim 13, further comprising a first, second and third feedstock tubes selectively coupled to the cold block body at the respective first, second and third filament passages, wherein the first, second and third feedstock tubes are arranged parallel relative to each other for directing parallel feeding of the respective filaments into the cold block, wherein the main nozzle flow passage is parallel to the first, second and third feedstock tubes.
